(19) United States
(12) Patent Application Publication
(10) Pub. No.: US 2010/0101165 A1
(43) Pub. Date: Apr. 29, 2010

(54) LOW-DENSITY FILLED POLYURETHANE FOAM

(75) Inventors: Jarrod Buffy, Waterville, OH (US); Inho Song, Chesterland, OH (US); William V. Pagryzinski, Leo, IN (US)

Correspondence Address: CALFEE HALTER & GRISWOLD, LLP, 800 SUPERIOR AVENUE, SUITE 1400, CLEVELAND, OH, 44114, US

(73) Assignee: Therma-Tru Corp., Maumee, OH (US)

(21) Appl. No.: 12/607,408

(22) Filed: Oct. 28, 2009

Related U.S. Application Data
(60) Provisional application No. 61/109,130, filed on Oct. 28, 2008.

(51) Int. Cl. E06B 3/72; C08J 9/04; B29C 44/18

(52) U.S. Cl. 52/309.4; 521/122; 264/45.3

(57) ABSTRACT

A filled polyurethane foam that includes a closed-cell polyurethane matrix having a mineral filler dispersed therein, wherein the polyurethane foam has a density of from about 1.5 to about 3.0 pounds per cubic foot, is described. The filled polyurethane foam can be prepared by mixing a polyol component that includes a blowing agent and an isocyanate component under reaction conditions, wherein one or both of the polyol component and the isocyanate component include a mineral filler, and allowing the mixed components to expand and cure. The filled polyurethane foam can be used as a door core that includes less polyurethane than polyurethane door cores that lack the mineral filler.

### RELATED APPLICATIONS

The present application claims priority from provisional application Ser. No. 61/109,103, entitled “Syntactic Polyurethane Door Core,” filed on Oct. 28, 2008. Provisional application Ser. No. 61/109,103 is incorporated herein by reference in its entirety.

### TECHNICAL FIELD

This invention relates generally to closed-cell polyurethane foam compositions. More particularly, this invention relates to low density, rigid polyurethane foam compositions including filler components for use as door cores.

### BACKGROUND

The production of rigid polyurethane foams by reacting organic isocyanates with polyhydroxyl compounds in the presence of a catalyst and a blowing agent has been previously described. See Heally, Polyurethane Foam: Proceedings, Symposium on Polyurethane Foams (1964), the disclosure of which is incorporated by reference herein. Typically, methylene diphenyl di-isocyanates and toluene di-isocyanates (i.e., isocyanates) react with alcohols, polyalcohol (polyol), blends of polyols, or polyol resins to form polyurethane compounds. See for Example U.S. Pat. No. 2,642,403, which describes cellular plastic compositions adapted to be foamed in place.

Polyurethane compositions have also been combined with aggregates or filler for various different applications. For example, polyurethanes have been used in cementitious compositions as described in U.S. Pat. Nos. 4,725,632, 4,777,208, and 4,816,503. Polyurethanes have also been used together with various fillers or aggregates to prepare foundry shapes used in casting low melting metals, as described in U.S. Pat. No. 4,946,876, in plywood patch applications as described in U.S. Pat. No. 5,952,053, and in two-component polyurethane adhesives, as described in U.S. Pat. No. 5,668,211.

Polyurethanes are generally either foams or elastomers. Including filler into polyurethane foams can be challenging, due in part to the high viscosity that results upon addition of the filler to the polyol. For example, U.S. Pat. No. 6,765,032 describes a method of suspending mineral fillers in polyurethane foams by treating them with an organic phosphate agent. U.S. Pat. No. 3,598,772 also describes a polyurethane foam that includes a mineral filler, but this patent describes incorporation of relatively large particles into a flexible, open celled foam structures, which is unsuitable for use as a door core due to its poor insulation characteristics.

Rigid polyurethane foams have previously been used as door cores. For example, doors made of steel skins including foamed-in-place cores formed between the skins are well known in the art. Doors including a foam core and simulated wood made of compression molded skins including a thermosetting resin have also been described (see U.S. Pat. No. 4,550,540). Doors made from metal or plastic skins and including a foamed polyurethane core provide a number of advantages, such as improved insulation characteristics, improved dimensional stability, and relatively high strength and durability.

While rigid polyurethane foam core provides doors with a number of advantages, the use of polyurethane foam within a door is relatively expensive. Accordingly, there is a need for low-density rigid polyurethane foam including a mineral filler (e.g., inexpensive filler) that is suitable for use in door core applications.

### SUMMARY

The present invention addresses the need for a low-density rigid polyurethane foam including a substantial amount of filler by providing a filled polyurethane foam that includes a closed-cell polyurethane matrix having a mineral filler dispersed therein, wherein the polyurethane foam has a density of from about 1.5 lbs/ft³ to about 3.0 lbs/ft³, which is suitable for use in door core applications.

Another aspect of the invention provides a method for making a filled, closed-cell polyurethane foam having a density of from about 1.5 lbs/ft³ to about 3.0 lbs/ft³ that includes the steps of (a) mixing a polyol component that includes a blowing agent and an isocyanate component under reaction conditions, wherein one or both of the polyol component and the isocyanate component include a mineral filler, and (b) allowing the mixed components to expand and cure.

A further aspect of the invention provides a door assembly that includes a frame positioned around the perimeter of the door, a pair of opposed sheets mounted on the frame, and a foamed core positioned within the frame and between the opposed sheets, in which the foamed core is a closed-cell polyurethane matrix having a mineral filler dispersed therein and having a density of from about 1.5 lbs/ft³ to about 3.0 lbs/ft³.

Yet another aspect of the invention provides a method of preparing a door assembly that includes the steps of mixing a polyol component that includes a blowing agent and an isocyanate component under reaction conditions to form a reaction mixture, wherein one or both of the polyol component and the isocyanate component include a mineral filler, holding an empty door assembly that includes a frame positioned around the perimeter of the door assembly, a pair of opposed sheets mounted on the frame, a door core space between the opposed sheets and within the frame, and an access hole within the frame, in place within a brace, introducing the reaction mixture into the door core space through the access hole, and allowing the reaction mixture to expand and cure in place to form a door core comprising a closed-cell polyurethane matrix having a mineral filler dispersed therein and having a density of from about 1.5 lbs/ft³ to about 3.0 lbs/ft³.

### BRIEF DESCRIPTION OF THE DRAWINGS

The above aspects and additional aspects, features and advantages will become readily apparent by describing in detail exemplary embodiments thereof with reference to the attached drawings:

FIG. 1 is a graph showing the change in polyol viscosity upon addition of filler, with different results being provided if the filler is calcium carbonate (squares), perlite (diamonds), or calcium carbonate mixed with a viscosity reducing agent (triangles).

FIG. 2 is a graph showing the change in viscosity of the slurry as an increasing percentage of filler is added. The slurry includes either polyol (squares) or isocyanate (circles).

FIG. 3 is a scanning electron microscope image of the cell structure of a polyurethane foam that does not include filler using a 100× magnification.

FIG. 4 is a scanning electron microscope image of the cell structure of a polyurethane foam that includes a mineral filler using a 100× magnification

FIG. 5 is a scanning electron microscope image of a strut of a polyurethane foam, showing incorporation of the mineral filler within the strut using a 1500× magnification.

FIG. 6 is a cross-sectional view taken along line 3-3 of FIG. 7B showing the frame of the present invention with the core positioned therein.

FIG. 7A is a front elevation view of a door assembly, and FIG. 7B is a side elevation view of a door assembly.

### DETAILED DESCRIPTION

The following discussion is presented to enable a person skilled in the art to make and use the invention. Various modifications will be readily apparent to those skilled in the art, and the general principles disclosed herein may be applied to other embodiments and applications without departing from the scope of the present invention as defined by the appended claims. Thus, the present invention is not intended to be limited to the embodiments shown, but is to be accorded the widest scope consistent with the principles and features disclosed herein.

The invention provides a filled polyurethane foam that includes a closed-cell polyurethane matrix having a mineral filler dispersed therein. The polyurethane foam is a low-density foam having a density of from about 1.5 to about 3.0 pounds per cubic foot. The density is determined by evaluating the “in place” density of the foam, as provided in the final product. The filled polyurethane foam can be prepared by mixing a polyol component that includes a blowing agent and an isocyanate component under reaction conditions, wherein one or both of the polyol component and the isocyanate component include a mineral filler, and allowing the mixed components to expand and cure. The filled polyurethane foam can be used as a door core that includes less polyurethane than polyurethane door cores that lack the mineral filler. Incorporation of the mineral filler can provide increased structural, thermal, fire resistance, and acoustic properties in comparison to otherwise identical polyurethane foam door cores that lack the mineral filler. Use of mineral filler can also significantly reduce the production costs of the doors, as a result of the mineral filler being significantly less expensive than polyurethane.

### Filled Polyurethane Foam Compositions

One aspect of the invention provides a filled polyurethane foam that includes a closed-cell polyurethane matrix having a mineral filler dispersed therein. Closed cell polyurethanes are those in which the foam bubbles within the polymer remain closed, trapping the gases that created the foam bubbles within and resulting in a rigid, non-flexible foam. A closed-cell polyurethane, as used herein, refers to a polyurethane in which most of the cells are have a closed rather than open configuration. Embodiments of the rigid polyurethane can include closed-cell polyurethanes in which at least 75% of the cells are closed cells, or embodiments in which at least 90% of the cells are closed cells.

The use of polyfunctional polyols in the preparation of the polyurethane foam encourages the formation of a three-dimensional cross-linked structure (i.e., the polyurethane matrix) that captures the blowing agent and/or other gases released during the preparation of the polyurethane. The polyurethane matrix is a continuous structure formed by the reaction of the polyol and polyisocyanate components, with the foam cell formation resulting from the formation of gas from the blowing agent included in the reaction mixture.

The filled polyurethane foam can contain one or more additional compounds used in the preparation of the polyurethane foam, such as catalyst(s), surfactant(s), water, additives, and blowing agents. In particular, it can be preferable to include blowing agent within the cells of the polyurethane foam. These additional compounds may be retained within the polyurethane matrix if they are not consumed or otherwise lost during preparation of the polyurethane foam.

The polyurethane foam is a low-density foam, meaning it has a relatively low weight per volume as compared with other polyurethane foams. The low density results from having a higher proportion of the space of the polyurethane foam being occupied by gas in foam cells rather than the polyurethane itself. In one embodiment, the low-density polyurethane foam has a density of from about 1.5 to about 3.0 pounds (lbs) per cubic foot (ft³).

The polyurethane foam also includes a mineral filler dispersed within the closed-cell polyurethane matrix. Preferably, the mineral filler is dispersed fairly evenly throughout the polyurethane matrix. For example, some embodiments of the polyurethane foam include mineral filler that is uniformly dispersed throughout the polyurethane matrix. Uniform dispersal can be obtained as a result of using mineral filler with a particle size of 50 microns or less, and as a result of foaming the polymer in place subsequent to mixing the mineral filler into the polyol or isocyanate component. The mineral filler is primarily present within the polyurethane, rather than foam cells, where it replaces a portion of the polyurethane in providing the structure for the cells. Keeping the mineral filler within the polyurethane itself is important to decrease the amount of polyurethane required, while not having a detrimental effect on the performance of the polyurethane, particular with regard to its insulating characteristics.

The mineral filler should have a particle size of less than about 50 microns. Use of a small particle size facilitates handling of the mineral filler, and in particular prevents clogging the openings in the nozzle of a standard high pressure mixing head. Small particles may also facilitate foaming of the polymer. Accordingly, some embodiments of the invention use mineral filler with an average particle size of from about 1 to about 50 microns. Other embodiments of the invention use mineral filler with an average particle size of from about 10 to about 30 microns. A particular particle size that can be used is about 20 microns. While the individual particle sizes within a batch may vary somewhat, they should not vary excessively, but rather should be fairly homogenous. Particle size can be measured using a sieve with an appropriate mesh size, or by other methods known to those skilled in the art.

Because the mineral filler serves, at least in part, to decrease the cost of the polyurethane foam by displacing polyurethane with less expensive mineral filler, it is preferable to include as much mineral filler as possible without having a significant detrimental effect on the properties of the polyurethane foam. For example, mineral fillers may be dispersed in rigid, closed-cell polyurethane foam at levels of up to about 70% weight of the overall composition. Accordingly, in some embodiments, the mineral filler provides from about 5 to about 70 weight percent of the polyurethane foam. In other embodiments, the mineral filler provides from about 10 to about 40 weight percent of the polyurethane foam, while in other embodiments the mineral filler provides from 10 to 30 weight percent of from 10 to 20 weight percent of the polyurethane foam.

Suitable mineral fillers include inorganic minerals of various types that can be suspended within the polyurethane foam without adverse effects on the foam itself, and in some cases with beneficial effects on the properties of the foam. If preferred, a plurality of different mineral fillers can be used. Suitable mineral fillers are selected from calcium carbonate, magnesium carbonate, zinc carbonate, mixed salts of magnesium and calcium such as dolomites, limestone, magnesia, barium sulfate, calcium sulfates, magnesium and aluminum hydroxides, silica, wollastonite, clays and other silica-alumina compounds such as kaolins, silico-magnesia compounds such as talc, mica, metallic oxides such as zinc oxide, iron oxides, titanium oxide, or mixtures thereof. More particularly, they may include natural or synthetic calcium carbonates, perlite, titanium dioxide, aluminum trihydrate, barium sulfate or calcium oxide. A particularly suitable mineral filler is calcium carbonate.

In some embodiments of the invention, the mineral-filled closed-cell polyurethane foam has improved structural properties as compared to an otherwise identical rigid polyurethane door core that does not contain mineral filler. For example, the filled polyurethane foam may possess improved properties as a thermal insulator as compared to an otherwise identical polyurethane foam that does not contain any inorganic mineral fillers. Alternately, or in addition, the filled polyurethane foam may possess improved acoustic properties as compared to an otherwise identical polyurethane foam that does not contain any inorganic mineral fillers. For example, an improved acoustic property would be the ability to function as an acoustic insulator.

In another embodiment of the invention, the closed-cell polyurethane foam including a mineral filler has increased fire resistance as compared to an otherwise identical polyurethane foam that does not contain a mineral filler. Because polyurethane foam is relatively flammable, replacement of a portion of the foam with relatively non-flammable mineral filler can significantly decrease the overall flammability of the mineral-filled polyurethane foam.

Embodiments of the filled polyurethane foam can exhibit a variety of useful physical properties. While these properties are listed as separate embodiments, please note that a given embodiment of the invention can exhibit one or more of these properties.

In one embodiment, the filled polyurethane foam can have a compressive strength (at 10% compression) of from about 10 pounds (lbs.) to about 50 lbs. In another embodiment of the invention, the filled polyurethane foam has an elastic modulus from about 310 psi to about 650 psi. In another embodiment, the filled polyurethane foam formed has an impact average of from about 0.0010 in/lbs to about 0.0031 in/lbs. In a further embodiment filled polyurethane foam has a latent change in density, 28 days after preparation, of less than about 3%. In yet a further embodiment, the filled polyurethane foam has a K factor of from about 0.22 btu-in/° F.-ft²-hr to about 0.12 btu-in/° F.-ft²-hr.

In another embodiment, the filled polyurethane foam has a rise time of from about 40 s to about 60 s. The rise time is the amount of time available for the filled polyurethane foam to rise within a mold or container before it gels, and is therefore should be somewhat shorter than the gel time. In a further embodiment, the filled polyurethane foam has a tack-free time of from about 90 s to about 170 s. In yet another embodiment, the-filled polyurethane foam has adhesion to a steel or reinforced plastic substrate as measured according to ASTM D1623-78 of from about 7 psi to about 35 psi. In yet another embodiment of the invention, the filled polyurethane foam has a reduced mass of between about 10% and about 45% as compared to an otherwise equivalent volume of polyurethane foam that does not contain mineral filler.

### Methods for Making Filled, Closed-Cell Polyurethane Foams

An additional aspect of the invention provides a method for making a filled, closed-cell polyurethane foam having a density of from about 1.5 lbs/ft³ to about 3.0 lbs/ft³. The method includes the steps of (a) mixing a polyol component that includes a blowing agent and an isocyanate component under reaction conditions, wherein one or both of the polyol component and the isocyanate component include a mineral filler, and (b) allowing the mixed components to expand and cure.

Polyols are higher molecular weight molecules having at least two isocyanate-reactive hydroxyl groups that are manufactured from an initiator and monomeric building blocks. They are most easily classified as polyether polyols, which are made by the reaction of epoxides with an active hydrogen containing starter compounds, and polyester polyols, which are made by the polycondensation of multifunctional carboxylic acids and hydroxyl compounds. The use of a mixture of two or more different polyols in the preparation of rigid, closed-cell polyurethane foams is preferred. Polyols, as described herein, include polyols, blends of polyols, and polyol resin.

Suitable polyols include compounds having from about 2 to about 8 isocyanate-reactive hydroxyl groups per molecule. The hydroxyl equivalent weight of the individual polyols may range from about 31 to about 2000 or more, but is preferably from about 300 to 700. Suitable polyols include compounds such as alkylene glycols (e.g., ethylene glycol, propylene glycol, 1,4-butane diol, 1,6 hexanediol and the like), glycol ethers and polyethers (such as diethylene glycol, triethylene glycol, dipropylene glycol, tripropylene glycol and the like), glycerine, trimethylolpropane, tertiary amine-containing polyols such as triethanolamine, triisopropanolamine, and ethylene oxide and/or propylene oxide adducts of ethylene diamine, toluene diamine and the like, polyether polyols, polyester polyols, and the like. Among the suitable polyether polyols are polymers of alkylene oxides such as ethylene oxide, propylene oxide and 1,2-butylene oxide or mixtures of such alkylene oxides. Such polyether polyols have a hydroxyl equivalent weight of from about 200 to about 2000 or more. Preferred polyethers are polypropylene oxides or polymers of a mixture of propylene oxide and a small amount (up to about 12 weight percent) ethylene oxide. These preferred polyethers may be capped with up to about 30% by weight ethylene oxide.

Particularly preferred are high functionality initiator polyols such as sucrose polyol, sorbitol polyol, and toluene polyol. High functionality polyols have a functionality of 4 or more. The higher functionality of these polyols provides a higher level of crosslinking, leading to the formation of a more rigid foam.

Polyester polyols are also suitable. These polyester polyols include reaction products of polyols, preferably diols, with polycarboxylic acids or their anhydrides, preferably dicarboxylic acids or dicarboxylic acid anhydrides. The polycarboxylic acids or anhydrides may be aliphatic, cycloaliphatic, aromatic and/or heterocyclic and may be substituted, such as with halogen atoms. The polycarboxylic acids may be unsaturated. Examples of these polycarboxylic acids include succinic acid, adipic acid, terephthalic acid, isophthalic acid, trimellitic anhydride, phthalic anhydride, maleic acid, maleic acid anhydride and fumaric acid. The polyols preferably have an equivalent weight of about 150 or less, and include ethylene glycol, 1,2- and 1,3-propylene glycol, 1,4- and 2,3-butane diol, 1,6-hexane diol, 1,8-octane diol, neopentyl glycol, cyclohexane dimethanol, 2-methyl-1,3-propane diol, glycerine, trimethylol propane, 1,2,6-hexane triol, 1,2,4-butane triol, trimethylolethane, pentaerythritol, quinitol, mannitol, sorbitol, methyl glycoside, diethylene glycol, triethylene glycol, tetraethylene glycol, dipropylene glycol, dibutylene glycol and the like.

Aromatic polyester polyols are a preferred type of polyol to use as a primary polyol ingredient of the polyol component, because they provide good rigidity to the foam at a given molecular weight. Preferred aromatic polyester polyols include esters of orthophthalic acid or orthophthalic anhydride and a glycol or glycol ether such as ethylene glycol or diethylene glycol. The preferred aromatic polyester polyols have a nominal functionality of about 2.0 and an equivalent weight from about 125-225, more preferably about 150-200.

In some embodiments it is preferred to employ, in conjunction with the preferred aromatic polyester polyol, one or more very low (up to about 125) equivalent weight tri- or higher-functional polyols. These polyols are often referred to as “crosslinkers”. Among these are glycerine, trimethylolpropane, and the like. These crosslinkers generally comprise a minor amount by weight of the isocyanate-reactive component, such as from about 2 to about 40 weight percent, based on the weight of the aromatic polyester polyol.

It is preferred to incorporate at least a small amount of a tertiary amine-containing polyol in the polyol component. The presence of this tertiary amine-containing polyol tends to increase the reactivity of the polyol component during the early stages of its reaction with the isocyanate. This in turn helps the reaction mixture to build viscosity more quickly when first mixed and applied, without unduly decreasing cream time, and thus reduces run-off or leakage. Such tertiary amine-containing polyols include, for example, triisopropanol amine, triethanolamine and ethylene and/or propylene oxide adducts of ethylene diamine having a molecular weight of up to about 400. The tertiary amine-containing polyol advantageously constitutes up to about 10, preferably up to about 5 percent of the combined weight of all isocyanate-reactive materials in the polyol component.

The polyol component may further comprise a small quantity of an amine-functional compound having one or more terminal isocyanate-reactive amine groups. These include polyols having a primary or secondary amine group, such as monoethanolamine, diethanolamine, monoisopropanolamine, diisopropanol amine and the like, and aliphatic amines such as aminoethylpiperazine. Also included among these compounds are the so-called aminated polyethers in which all or a portion of the hydroxyl groups of a polyether polyol are converted to primary or secondary amine groups. Suitable such aminated polyethers are sold by Huntsman Chemicals under the trade name JEFFAMINE®. Typical conversions of hydroxyl to amine groups for these commercial materials range from about 70-95%, and thus these commercial products contain some residual hydroxyl groups in addition to the amine groups. Preferred among the aminated polyethers are those having a weight per isocyanate-reactive group of about 100-1700, and having 2-4 isocyanate-reactive groups per molecule.

In order to make the desired rigid foam, the isocyanate reactive materials used in the polyol component preferably have an average nominal functionality of from about 2.2 to about 8, and preferably from about 4 to about 8 isocyanate-reactive hydroxyl groups per molecule. By a nominal functionality, it is meant that the functionality expected is based upon the functionality of the initiator molecule, rather than the actual functionality of the final polyether after manufacture. In addition, the equivalent weight (weight per equivalent of isocyanate-reactive groups) of the fully formulated isocyanate-reactive component is advantageously from about 350 to about 600, preferably from about 400 to about 550. Accordingly, the functionality and equivalent weight of the individual polyols are preferably selected so the foregoing parameters are met.

The polyol component also contains a blowing agent. Examples of suitable blowing agents include chlorofluorocarbons, hydrochlorofluorocarbons, hydrofluorocarbons, chlorocarbons and hydrocarbons such as cyclopentane, or blends of pentanes. In addition, water may be used as a blowing agent. Water reacts with the isocyanate to form carbon dioxide gas that causes the reaction mixture to expand.

The blowing agent is used in an amount sufficient to provide the foam with a density of from about 1.5 lbs/ft³ to about 3.0 lbs/ft³. Preferably, enough blowing agent is used to expand the reactive components of the formulation that form the polyurethane at least about 10 times, and more preferably from 25 times to 30 times their original volume.

The blowing agent preferably also increase the ability of the filled polyurethane foam to function as a thermal insulator. Chlorofluorocarbons, hydrochlorofluorocarbons, hydrofluorocarbons, and hydrocarbons all will help increase the thermal insulation character of a filled polyurethane foam, and it may therefore be preferable to use them as blowing agents in some embodiments.

While the blowing agent can provide the benefit of increased thermal insulation when retained in the cells of a foamed polyurethane polymer, the blowing agent is typically one of the more expensive materials used in preparing foamed polymers, and it is therefore preferable to decrease the amount of blowing agent required to obtain a filled polyurethane foam with the desired properties. Interestingly, it has been discovered that the mineral filler may reduce the amount of blowing agent needed to obtain a foamed polymer with a density from about 1.5 lbs/ft³ to about 3.0 lbs/ft³. While not intending to be bound by theory, it is believed that particles of mineral filler with a size of 50 microns or less may function as a nucleating agent that increases the foaming of the nascent polyurethane foam. Accordingly, in some embodiments a decreased amount (10%, 20, 30%, 40%, or 50% less) of blowing agent may be used in the production of polyurethane foam that includes a mineral filler with a size of 50 microns or less. A particularly preferred mineral filler for decreasing the amount of blowing agent required is calcium carbonate.

In addition to the blowing agent, the polyol component may also include one or more catalysts, surfactants, water, or other additives.

A suitable polyol formulation for use with appliances is described in Huntsman Polyurethane Book, Table 16-1, p. 251, the disclosure of which is incorporated by reference herein. This exemplary polyol formulation, referred to herein as the appliance polyol, and which is reproduced below in TABLE 1, can be used in certain embodiments described herein. The percentage amounts of the compounds in the table are provided as weight percents relative to the overall mixture that provides the polyurethane foam.

TABLE 1

| Ingredient | Amount |
|---|---|
| Sucrose polyol (OH v 440) | 14.3% |
| Aromatic amine polyol (OH v 400) | 12.5% |
| Glycerol polyol (OH v 540) | 1.1% |
| Catalyst | 1.1% |
| Surfactant | 0.7% |
| Additives | 0.4% |
| Blowing agent | 11.8% |
| Water | 0.7% |

The method for making a filled, closed-cell polyurethane foam having a density of from about 1.5 lbs/ft³ to about 3.0 lbs/ft³ also includes use of an isocyanate component. Suitable isocyanates include those commonly used in preparing polyurethanes, including aromatic, aliphatic and cycloaliphatic polyisocyanates. Aromatic polyisocyanates are generally preferred based on cost, availability and properties. Exemplary polyisocyanates include, for example, m-phenylene diisocyanate, 2,4- and/or 2,6-toluene diisocyanate (TDI), the various isomers of diphenylmethane diisoyanate (MDI), hexamethylene 1,6-diisocyanate, tetramethylene-1,4-diisocyanate, cyclohexane-1,4-diisocyanate, hexahydrotoluene diisocyanate, hydrogenated MDI (H.sub.12 MDI), naphthylene-1,5-diisocyanate, methoxyphenyl-2,4-diisocyanate, 4,4′-biphenylene diisocyanate, 3,3′-dimethyoxy-4,4′-biphenyl diisocyanate, 3,3′-dimethyldiphenylmethane-4,4′-diisocyanate, 4,4′,4″-triphenylmethane diisocyanate, polymethylene polyphenylisocyanate, toluene-2,4,6-trilsocyanate, and 4,4′-dimethyldiphenylmethane-2,2′,5,5′-tetraisocyanate. Preferred polyisocyanates include TDI, MDI and the so-called polymeric MDI products, which are a mixture of polymethylene polyphenylisocyanates in monomeric MDI.

One or both of the polyol component and the isocyanate component include a mineral filler. The mineral filler can be one or more of the suitable mineral fillers described herein. The particles can have a particle size less than 50 microns, and can provide up to 70% of the weight percent of the final foamed polyurethane. In one embodiment, the mineral filler is added only to the polyol component before mixing. In another embodiment, the mineral filler is added to only the isocyanate component before mixing. In a further embodiment, the mineral filler is added to both the polyol and the isocyanate components before mixing. The mineral filler can be incorporated into the polyol or the isocyanate component by simple mechanical stirring.

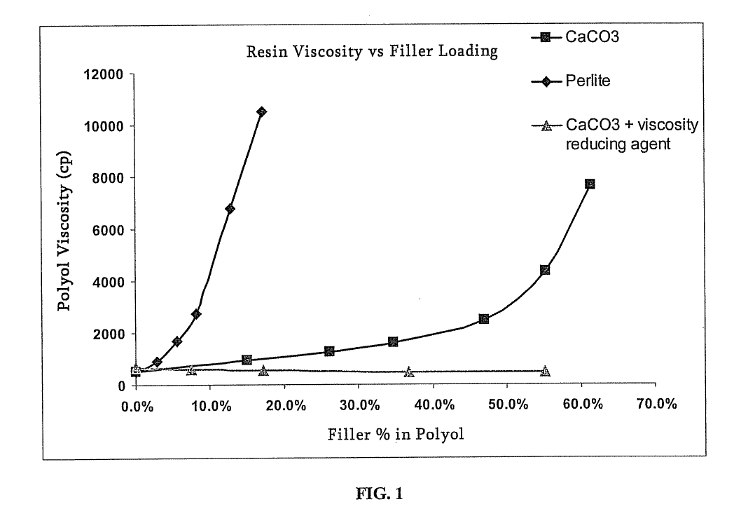

The graph in FIG. 1 shows the change in polyol viscosity upon addition of calcium carbonate, perlite, and calcium carbonate mixed with a viscosity reducing agent (e.g., 2-butoxyethanol) as mineral fillers. This figure demonstrates that the addition of minerals to polyol results in a rapid increase in viscosity. FIG. 1 also demonstrates that viscosity reducing agents added to the polyol help decrease the rise in viscosity.

The fillers may be added to the polyol component, but this can result in a rapid increase in viscosity. Incorporation of fillers into the isocyanate component, however, results in a less rapid rise in viscosity as a function of filler loading. Furthermore, when the ratio of the isocyanate to the other reactive component(s) (the I/R ratio) is greater than 1, i.e., more isocyanate is present than other reactive component(s), the weight percent of filler in isocyanate will be decreased relative to filler added to polyol for the same weight percent filler in the final filled polyurethane foam. In addition, there are often additional reactive components present in the reaction mixture that can react with the isocyanate component. Incorporation of the filler into the isocyanate component in these instances further reduces the filler loading relative to any of these additional reactive components.

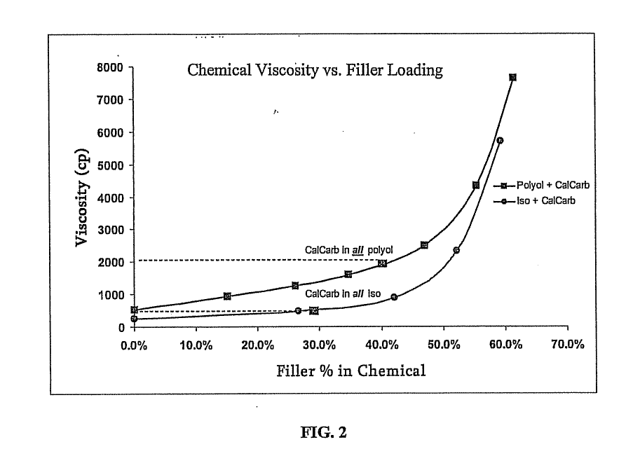

FIG. 2 illustrates the viscosity of a polyol-mineral slurry and an isocyanate-mineral slurry, as a function of filler weight percent. The dashed lines within the graph mark the amount of filler required to make mineral-filled polyurethane with a final mineral loading of 20%, by weight. Adding mineral to the isocyanate component results in a slurry with less than half the viscosity than is needed if the mineral is added to the polyol component.

Addition of mineral to isocyanate in open-air mixing over a period of 20 minutes showed no deleterious effects. An isocyanate-mineral slurry prepared at nearly 60% mineral by weight remained very homogenous without agitation over a period of 3 days. Reaction of the isocyanate-mineral slurry with polyol resulted in a polyurethane foam with similar characteristics to polyurethane foam prepared by mixing isocyanate and a polyol-mineral slurry.

The reaction of the polyol and isocyanate is typically facilitated by a catalyst. Suitable catalysts are known to those skilled in the art, and include the general classes of amine compounds and organometallic complexes such as bismuth octanoate, phenylmercuric neodeconate, and various tin catalysts. Suitable amino catalysts include N-alkyl morpholines such as N-methyl morpholine and N-ethyl morpholine; tertiary amines such as trimethyl amine, triethyl amine, tetramethyl guanidine, triethyl diamine, N,N,N′,N′-tetramethyl-1,3-butane diamine; and piperizines such as N-methyl piperazine. Suitable tin catalysts include dialkyl tin laureates such as dibutyl tin dilaurate, dibutyl tin bis(2-ethyl hexoate), dibutyl tin diacetate, stannous oleate, and stannous octoate. Catalysts are provided in amounts from about 0.1% to about 2% by weight relative to the amount of polyol used.

Surfactants can also be included to modify the characteristics of the filled polyurethane foam. The surfactants function to emulsify the liquid components, regulate cell size, and stabilize cell structure. Examples of surfactants include polydimethylsuloxane-polyoxyalkylene block copolymers, nonylphenol ethoxylates, alkylene adducts of ethylene diamine, and polyoxyalkylene esters of long chain fatty acids and sorbitan.

Prior to mixing with the isocyanate, the polyol component is prepared. The polyol component includes the blowing agent, and can include other compounds used in the preparation of the filled polyurethane foam, such as catalyst and surfactant, and in some embodiments the mineral filler. Preparation of the polyol component can be carried out in any suitable container, such as a water jacketed carbon steel day polyol load-cell tank.

A filled polyurethane foam according to the invention is prepared by mixing the polyol and isocyanate components. The temperature of mixing and foaming is conveniently from about 50° to about 100° F., with temperatures from about 70° to about 80° F. being preferred, although somewhat higher temperatures can be tolerated. Mixing of preferred ratios of the components is typically carried out within the mix head of a high pressure polyurethane dispensing unit. The polyol and isocyanate components are brought together under high pressure (e.g., 1800 p.s.i) to assure proper mixing of the two components, and is then ejected from the mixing head through a nozzle to fill the desired cavity or shape with the filled polyurethane foam.

In one embodiment, the filled polyurethane foam can be formed by reacting the polyol with isocyanate in a standard high-pressure foam dispensation head, which may include, but is not limited to a Hennecke™ MQ18 mixhead, capable of mixing filled foams, which includes mechanical self-cleaning, high-pressure mixing capable of free pour, open-mold dispense or closed-mold injection where the components are mixed by impingement in a mixing chamber which, at the end of the pouring process self-cleans by mechanically-driven pistons. The aforementioned mixhead will be specially equipped to accommodate the abrasive nature of mineral-filled polyol by incorporating a variety of components, such as dual hydraulic valving, hardened pour piston, block and orifices, space between the chemical block and hydraulic cylinder, a sufficient amount of high-pressure flexible hose, a control box, and suitable needles and orifices for polyurethane delivery.

In another exemplary embodiment of the invention, the filled polyurethane foam used in the compositions described herein is formed by reacting the polyol with isocyanate in a standard high-pressure dispensation head, where the isocyanate and polyol (which may additionally contain catalyst(s), surfactant(s), water, additives, and/or a blowing agent) are delivered, separately, to the high-pressure dispensation head via standard individual metering groups.

The ratios of the two components are advantageously selected so as to provide an isocyanate index (ratio of isocyanate to isocyanate-reactive groups of the polyol) of about 0.7, preferably about 0.9, more preferably about 0.98, to about 1.5, preferably to about 1.25, more preferably to about 1.1. It is especially preferred to formulate the polyol and isocyanate components so that these isocyanate indices are achieved using comparable volumes of each component. Preferably, the polyol component and the isocyanate component are mixed in a volume ratio of from about 4:1 to 1:4, preferably about 3:1 to 1:3, more preferably from about 2:1 to 1:2, most preferably about 1:1 to about 1:2.

The mixed components are allowed to expand and cure within the desired shape subsequent to release from the mixing head. The desired shape may be, for example, a mold to create a door core, or within a door itself to form a door core. The mixed material rises and releases heat as a result of the exothermic nature of the reaction, and typically forms a rigid foam within about 3-5 minutes.

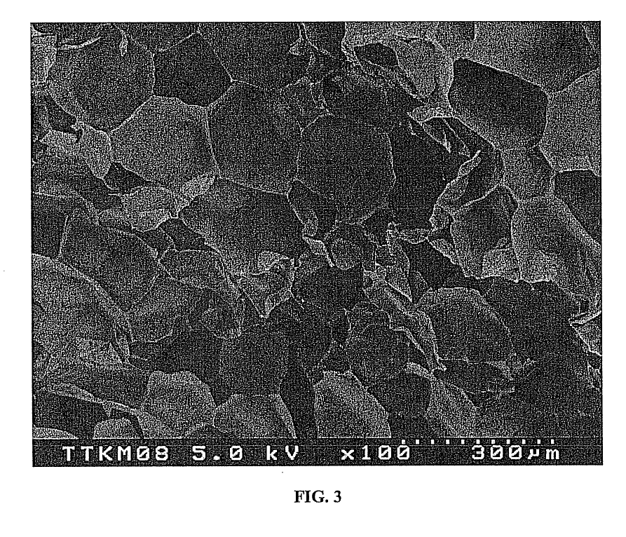

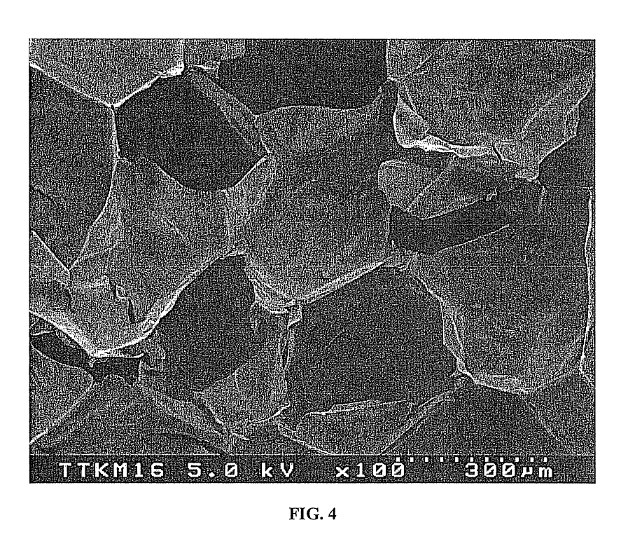

Foams prepared using the components and procedures described above were evaluated using an electron microscope to confirm that the foams thus prepared were closed cell foams. As shown in FIG. 3, the polymer formed clearly exhibits a substantially close-cell foam structure when no filler was included in the either the polyol or isocyanate component. A closed cell foamed polymer is the preferred structure for door core materials, as closed cell foams are more rigid and function as better insulators. More significantly, FIG. 4 shows that the foamed polymer retains the substantially close-cell foam structure even when a mineral filler has been included.

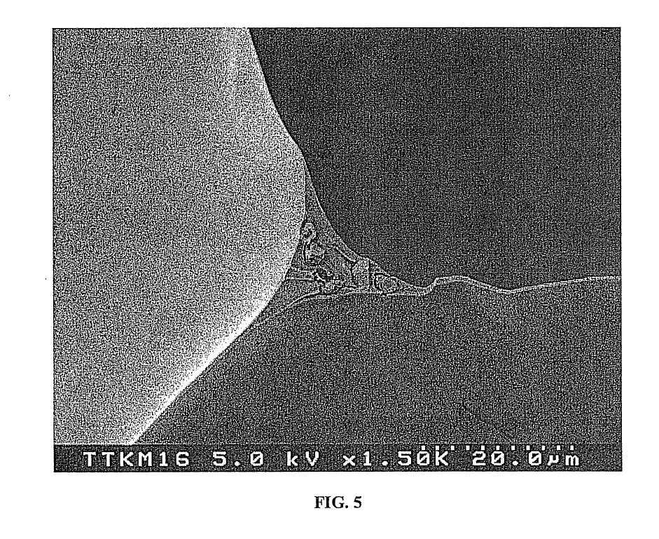

As to FIG. 5, in this figure the filler can be seen to be highly concentrated in the intersection of three foam cells (windows). The intersection of three or more windows, like that depicted in FIG. 5, is commonly known as the strut. The high concentration of polyurethane filler present in the strut, as depicted in FIG. 5, indicates good incorporation of the filler into the polyol. The high concentration of polyurethane filler present in the strut, as depicted in FIG. 5, also indicates that the mineral filler does not migrate during the manufacturing process.

### Filled Closed-Cell Foamed Polyurethane as a Door Core

Also described herein is a door assembly including a foamed polyurethane core. A door can be any suitable shape for closing an opening, but is typically rectangular. The door can be prepared from a variety of suitable materials, such as wood, metal, steel, or plastic. One embodiment of the invention provides a door assembly including a rectangular frame, a pair of opposed sheets mounted on the frame, and a foamed core positioned within the frame and between the opposed sheets, in which the foamed core includes a closed-cell polyurethane matrix having a mineral filler dispersed therein and having a density of from about 1.5 lbs/ft³ to about 3.0 lbs/ft³.

The filled polyurethane foam can have any of the characteristics described herein. For example, the mineral filler included in the door can have an average particle size from about 10 to about 30 microns, and/or the mineral filler can provides from about 20 to about 40 weight percent of the foamed core.

Preferably, the foamed core is bonded to the materials making up the door. For example, in a door assembly including a rectangular frame and a pair of opposed sheets mounted on the frame, the foamed core can be bonded to the opposed sheets (i.e., the interior surfaces of the opposed sheets). Depending on the material used to manufacture the door, the mineral-filled polyurethane foam may have a substantial adhesion to wood, a substantial adhesion to metal, a substantial adhesion to steel, or a substantial adhesion to plastic.

A feature of the inventive compositions described herein is that door cores made from the mineral filled polyurethane foam have increased structural, thermal, fire resistant and acoustic properties as compared to a rigid polyurethane door core.

Another feature of the inventive compositions described herein is that door cores made from the mineral filed polyurethane foam herein described require 45% less polyurethane, per door, as compared to an otherwise identical door core made from an otherwise identical polyurethane foam that does not contain any inorganic fillers.

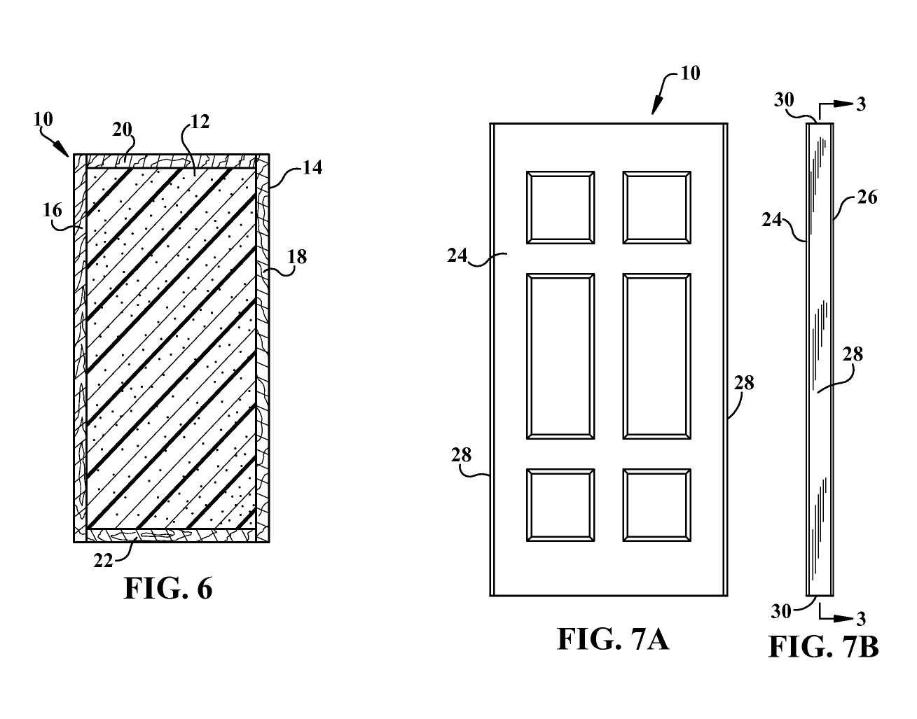

An embodiment of the door assembly that includes a foamed door core will now be described in greater detail, with reference to FIGS. 6 and 7. The door assembly 10 includes a core 12 positioned within a frame 14. The core 12 can be an inserted core or a core formed in-situ. The core 12 is composed of a mineral filled foamed polyurethanes, as described herein. In-situ formed cores include cores developed from reaction injection molding. As shown in FIG. 6, the frame 14 is positioned around the perimeter of the door, and includes a first stile 16 and second stile 18. The stiles 16 and 18 are parallel to one another. The stiles 16 and 18 are positioned in a perpendicular relationship to a first rail 20 and a second rail 22. The stiles and rails can be made of wood or another suitable material such as metal or plastic.

As shown in FIGS. 7A and 7B, the door assembly 10 also includes a first sheet 24 and an opposed second sheet 26. The first sheet 24 and second sheet 26 can be wood, fiberglass, or metal, or can be a molded plastic made by a variety of casting and deposition processes. The door assembly 10 includes vertical edges 28 and horizontal edges 30. The edges are adjacent and substantially perpendicular to the skins 24 and 26. The edges 28 and 30 can also include weatherstrip members (not shown).

For further description of door assembly including a foamed core, see U.S. Pat. No. Re. 36,240, the disclosure of which is incorporated by reference herein. The frame in FIG. 6 has a rectangular geometric configuration. However, it should be understood that the frame can be arranged in a variety of geometric configurations depending upon the application.

The present invention also provides a method of preparing a door assembly that includes a door core made of a filled. rigid polyurethane foam. The method includes the step of preparing a reaction mixture. A reaction mixture is prepared by mixing a polyol component that includes a blowing agent and an isocyanate component under reaction conditions, wherein one or both of the polyol component and the isocyanate component include a mineral filler.

The method of preparing the door assembly also includes the step of holding an empty door assembly in place within a brace. The empty door assembly is a door assembly as described above, but not yet including a door core. Accordingly, the empty door assembly includes a frame positioned around the perimeter of the door assembly, a pair of opposed sheets mounted on the frame, a door core space between the opposed sheets and within the frame. The door core space is the area occupied by the door core in the completed door assembly. The empty door assembly also includes an access hole within the frame. The access hole can be positioned on a stile or rail of the frame, and be sufficiently large to allow entry of a foam head nozzle for delivery of the reaction mixture.

The brace is an apparatus that includes a pair of parallel platens, which are large steel plates with a size equal to or greater than the sheets used in the door assembly, which are configured to be positioned over the sheets of the door to hold the sheets and the frame of the door in place while the reaction mixture is placed within the door core space. Expansion of the polymer within the door core can create significant pressure on the frame and door sheets, and therefore it can be important to hold them in place during the expansion and curing of the polyurethane foam. Accordingly, the platen should apply sufficient pressure against the frame and door sheets to prevent them from becoming distorted or misaligned during preparation of the door assembly.

Once the empty door assembly has been positioned and held within the brace, the reaction mixture is introduced into the door core space through the access hole. The reaction mixture is typically introduced immediately after mixing the polyol and isocyanate components together in the mix head, and can be delivered into the door core space using a foam head nozzle/The reaction mixture to expand and cure in place to form a door core made of a closed-cell polyurethane matrix having a mineral filler dispersed therein and having a density of from about 1.5 lbs/ft³ to about 3.0 lbs/ft³. In some embodiments, it may also be preferred to heat the frame and sheets of the door assembly while the reaction mixture expands and cures to facilitate the reaction. For example, it may be preferably for the brace to apply a temperature of about 100° F. to the door assembly during this process.

The filled polyurethane used to form the door core can have any of the characteristics of the filled polyurethane described herein. For example, in some embodiments, the mineral filler has an average particle size from about 10 to about 30 microns, while in the same or other embodiments the mineral filler provides from about 10 to about 40 weight percent of the foamed core.

### EXAMPLE

The invention will be further described by reference to the following detailed example. This example is offered to further illustrate the various specific and preferred embodiments and techniques. It should be understood, however, that many variations and modifications may be made while remaining within the scope of the present invention

### Evaluation of the Properties of Filled Polyurethane Foams

A variety of filled polyurethane foams were prepared. The polyurethane foams were prepared using the polyol blend described in Table 1, with polymeric MDI providing the isocyanate component, with a reactive chemical ratio of isocyanate to polyol of about 1.69:1. The components were mixed in a Hennecke™ MQ18 mixhead and delivered to a mold to evaluate the various properties shown in Tables 2 and 3 below, such as gel time, cream time, density, minutes to fill, rise height, rise rate (in feet), viscosity, and specific gravity. Table 2 shows the results when no additional water was added to the mixture, while Table 3 shows the results when about 6% water was used. For the trials carried out with additional water, additional isocyanate was also added to compensate for losses of isocyanate to reaction with water.

TABLE 2

| | Filler Concentration Trial | | | | | | | | |
|---|---|---|---|---|---|---|---|---|---|
| No Water | % Filler on PU - isocyanate | | | | | % Filler on PU polyol | | | |
| Added | 0 | 4 | 9 | 15 | 20 | 5 | 9 | 15 | 20 |
| gel time | 58 | 63 | 71 | 66 | 72 | | | 63 | 62 |
| cream | 10 | 9 | 9.5 | 7 | 5 | | 10 | 10 | 7 |
| time | | | | | | | | | |
| Density | 1.34 | 1.42 | 1.53 | 1.6 | 1.75 | | | 1.48 | 1.58 |
| Min-Fill | 2114 | 2226 | 2327 | | 2675 | | | 2378 | |
| (tot) | | | | | | | | | |
| rise height | 16 | 15.5 | 14.5 | 13.4 | 12.4 | | | 14.5 | 14.1 |
| rise rate | 0.17 | 0.15 | 0.16 | 0.14 | 0.15 | | | 0.14 | 0.13 |
| viscosity | | 294 | 460 | 585 | 880 | | 848 | 2225 | 4150 |
| spec. grav | | 1.27 | 1.32 | 1.39 | 1.32 | | 1.17 | 1.2 | 1.29 |

The other variables in these trials were the weight percent of mineral filler added, and whether or not the mineral filler was added to the isocyanate component or the polyol component before these were combined in the mixing head. Note that the mineral filler used in these trials was calcium carbonate.

TABLE 3

| | Filler Concentration Trial | | | | | | | | |
|---|---|---|---|---|---|---|---|---|---|
| Water | % Filler on PU - | | | | | | | | |
| Added to | isocyanate | | | | | % Filler on PU polyol | | | |
| Resin | 0 | 4 | 9 | 15 | 20 | 5 | 9 | 15 | 20 |
| gel time | | | | | | | | | |
| cream | | | | | | | | | |
| time | | | | | | | | | |
| Density | | | | 1.24 | 1.36 | | | 1.32 | 1.32 |
| Min-Fill | | | | 2114 | 2067 | | | 2089 | 2151 |
| (tot) | | | | | | | | | |
| rise height | | | | 16 | 16 | | | 18.4 | 16.4 |
| rise rate | | | | | | | | | |
| viscosity | | | | | | | | | |
| spec. grav | | | | | | | | | |

The results show that an preferred cream time (i.e., the point at which the mixture appears less liquid and more like a foamed cream) for door core preparation can be maintained at various levels of filler, with no appreciable drop in the cream time at up to 15% filler when the filler is added to the polyol component. It is preferable to retain a cream time of about 10 seconds for filling a door core, as this provides sufficient time for the polymer mixture to permeate the various portions of the mold or the door core before it becomes too viscous. Note that cream time can be increased or decreased by using a catalyst that provides a different reaction rate.

The results also show that addition of water to either the isocyanate component or the polyol component increases the ability of the reaction mixture to exhibit an increased rise height at higher levels of filler. Maintaining a good rise height helps assure that the foam retains a low density by expanding to fill the mold or door core to its full height before expansion stops as a result of the increased hardening and viscosity of the reaction mixture. For example, as shown in Table 3, a rise height of 16 is maintained at 15% and 20% weight percent levels of mineral filler if additional water is added to the reaction mixture.

The complete disclosures of the patents, patent documents, and publications cited herein are incorporated by reference in their entirety as if each were individually incorporated, regardless of whether they are individually incorporated by reference. Various modifications and alterations to this invention will become apparent to those skilled in the art without departing from the scope and spirit of this invention. It should be understood that this invention is not intended to be unduly limited by the illustrative embodiments and examples set forth herein and that such examples and embodiments are presented by way of example only with the scope of the invention intended to be limited only by the claims set forth herein as follows.

What is claimed is:

1. A filled polyurethane foam, comprising a closed-cell polyurethane matrix having a mineral filler dispersed therein, wherein the polyurethane foam has a density of from about 1.5 lbs/ft³ to about 3.0 lbs/ft³.

2. The filled polyurethane foam of claim 1, wherein the mineral filler has an average particle size of from about 1 to about 50 microns.

3. The filled polyurethane foam of claim 2, wherein the mineral filler has an average particle size from about 10 to about 30 microns.

4. The filled polyurethane foam of claim 1, wherein the mineral filler provides from about 10 to about 40 weight percent of the polyurethane foam.

5. The filled polyurethane foam of claim 1, wherein the mineral filler provides from about 10 to about 40 weight percent of the polyurethane foam and has an average particle size from about 10 to about 30 microns.

6. The filled polyurethane foam of claim 1, wherein the mineral filler is evenly dispersed.

7. The filled polyurethane foam of claim 1, wherein the mineral filler increases the fire resistance of the filled polyurethane foam in comparison to an equivalent polyurethane foam lacking the mineral filler.

8. A method for making a filled, closed-cell polyurethane foam having a density of from about 1.5 lbs/ft³ to about 3.0 lbs/ft³ comprising the steps of (a) mixing a polyol component that includes a blowing agent and an isocyanate component under reaction conditions, wherein one or both of the polyol component and the isocyanate component include a mineral filler, and (b) allowing the mixed components to expand and cure.

9. The method of claim 8, wherein the isocyanate component comprises diphenylmethane diisocyanate or toluene diisocyanate or polymeric forms thereof.

10. The method of claim 8, wherein the polyol component comprises a sucrose polyol and an aromatic amine polyol.

11. The method of claim 8, wherein the mineral filler has an average particle size from about 10 to about 30 microns.

12. The method of claim 8, wherein the mineral filler provides from about 20 to about 40 weight percent relative to the other components.

13. The method of claim 8, wherein only the isocyanate component includes the mineral filler.

14. The method of claim 8, wherein the amount of blowing agent required to obtain a density of from about 1.5 lbs/ft³ to about 3.0 lbs/ft³ is decreased by the presence of the mineral filler.

15. A door assembly comprising a frame positioned around the perimeter of the door, a pair of opposed sheets mounted on the frame, and a door core positioned within the frame and between the opposed sheets, the foamed core comprising a closed-cell polyurethane matrix having a mineral filler dispersed therein and having a density of from about 1.5 lbs/ft³ to about 3.0 lbs/ft³.

16. The door assembly of claim 15, wherein the mineral filler has an average particle size from about 10 to about 30 microns.

17. The door assembly of claim 15, wherein the mineral filler provides from about 10 to about 40 weight percent of the foamed core.

18. The door assembly of claim 15, wherein the foamed core is bonded to the opposed sheets.

19. The door assembly of claim 15, wherein the frame is a rectangular frame.

20. The door assembly of claim 15, wherein the mineral filler is evenly dispersed.

21. The door assembly of claim 15, wherein the mineral filler is calcium carbonate.

22. A method of preparing a door assembly comprising the steps of;
mixing a polyol component that includes a blowing agent and an isocyanate component under reaction conditions to form a reaction mixture, wherein one or both of the polyol component and the isocyanate component include a mineral filler,
holding an empty door assembly comprising a frame positioned around the perimeter of the door assembly, a pair of opposed sheets mounted on the frame, a door core space between the opposed sheets and within the frame, and an access hole within the frame, e, in place within a brace,
introducing the reaction mixture into the door core space through the access hole, and
allowing the reaction mixture to expand and cure in place to form a door core comprising a closed-cell polyurethane matrix having a mineral filler dispersed therein and having a density of from about 1.5 lbs/ft³ to about 3.0 lbs/ft³.

23. The method of preparing a door assembly of claim 22, wherein the brace applies heat and pressure against the frame and sheets of the door assembly while the reaction mixture expands and cures in place.

24. The method of preparing a door assembly of claim 22, wherein the mineral filler has an average particle size from about 10 to about 30 microns.

25. The method of preparing a door assembly of claim 22, wherein the mineral filler provides from about 10 to about 40 weight percent of the foamed core.
